(19) United States
(12) Patent Application Publication
(10) Pub. No.: US 2026/0112847 A1
(43) Pub. Date: Apr. 23, 2026

(54) GROUNDING SPRING, GROUNDING TERMINAL ASSEMBLY AND CONNECTOR

(71) Applicants: Sibas Electronics (Xiamen) Co. Ltd., Xiamen City (CN); Tyco Electronics (Shanghai) Co., Ltd., Shanghai (CN)

(72) Inventors: Hart (Hua) He, Shanghai (CN); Yong (Chris) Wang, Shanghai (CN); Yingchun (David) Wang, Shanghai (CN); Hui (Blaze) Peng, Xiamen (CN)

(73) Assignees: Sibas Electronics (Xiamen) Co. Ltd., Xiamen City (CN); Tyco Electronics (Shanghai) Co., Ltd., Shanghai (CN)

(21) Appl. No.: 19/363,975

(22) Filed: Oct. 21, 2025

(30) Foreign Application Priority Data
Oct. 22, 2024 (CN) 202422558153.X

(51) Int. Cl. H01R 13/6584; H01R 13/24; H01R 13/58; H01R 13/639

(52) U.S. Cl. CPC H01R 13/6584; H01R 13/2435; H01R 13/5812; H01R 13/639

(57) ABSTRACT

A grounding spring includes a C-shaped clamping portion and an elastic contact portion. The C-shaped clamping portion clamps a grounding terminal of a connector to make electrical contact with the grounding terminal. The elastic contact portion abuts against an inner side of an outer shielding shell of the connector to make electrical contact with the outer shielding shell. The grounding spring electrically connects the grounding terminal to the outer shielding shell.

### CROSS-REFERENCE TO RELATED APPLICATION

This application claims the benefit of the filing date under 35 U.S.C. § 119 (a)-(d) of Chinese Patent Application No. 202422558153.X, filed on Oct. 22, 2024.

### FIELD OF THE INVENTION

The present invention relates to a grounding spring and, more particularly, to a grounding spring, a grounding terminal assembly including the grounding spring, and a connector including the grounding terminal assembly.

### BACKGROUND OF THE INVENTION

A power connector typically includes a terminal retainer, a power terminal, a grounding terminal mounted on the terminal retainer, an inner insulating shell sleeved on the terminal retainer, and an outer shielding shell sleeved on the inner insulating shell. In order to achieve an electrical connection between the grounding terminal and the outer shielding shell, it is usually necessary to sleeve a cylindrical grounding member on the grounding terminal, and a flange portion of the cylindrical grounding member is in electrical contact with the outer shielding shell. However, the structure of the cylindrical grounding member is complicated, which results in the complicated structure of the inner insulating shell and the outer shielding shell. Moreover, additional components are needed for positioning and mounting the cylindrical grounding member, which increase the cost of the connector and reduce the production efficiency of the connector.

### SUMMARY OF THE INVENTION

A grounding spring includes a C-shaped clamping portion and an elastic contact portion. The C-shaped clamping portion clamps a grounding terminal of a connector to make electrical contact with the grounding terminal. The elastic contact portion abuts against an inner side of an outer shielding shell of the connector to make electrical contact with the outer shielding shell. The grounding spring electrically connects the grounding terminal to the outer shielding shell.

### BRIEF DESCRIPTION OF DRAWINGS

The invention will now be described by way of example with reference to the accompanying figures, of which:

FIG. 1 is a perspective view of a grounding terminal assembly according to an exemplary embodiment;

FIG. 2 is a perspective view of a grounding spring of the grounding terminal assembly of FIG. 1;

FIG. 3 is a front side partial exploded view of the grounding terminal assembly of FIG. 1 and a terminal retainer according to an exemplary embodiment;

FIG. 4 is a front side perspective assembly view of the grounding terminal assembly of FIG. 1 and the terminal retainer of FIG. 3;

FIG. 5 is a rear side partial exploded view of the grounding terminal assembly of FIG. 1 and the terminal retainer of FIG. 3;

FIG. 6 is a rear side perspective assembly view of the grounding terminal assembly of FIG. 1 and the terminal retainer of FIG. 3;

FIG. 7 is a partial exploded view of an insert module and an inner insulating shell according to an exemplary embodiment;

FIG. 8 is a perspective assembly view of the insert module of FIG. 7 and the inner insulating shell of FIG. 7;

FIG. 9 is a partial exploded view of a connector module and an outer shielding shell according to an exemplary embodiment; and

FIG. 10 is a perspective assembly view of the connector module of FIG. 9 and the outer shielding shell of FIG. 9.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

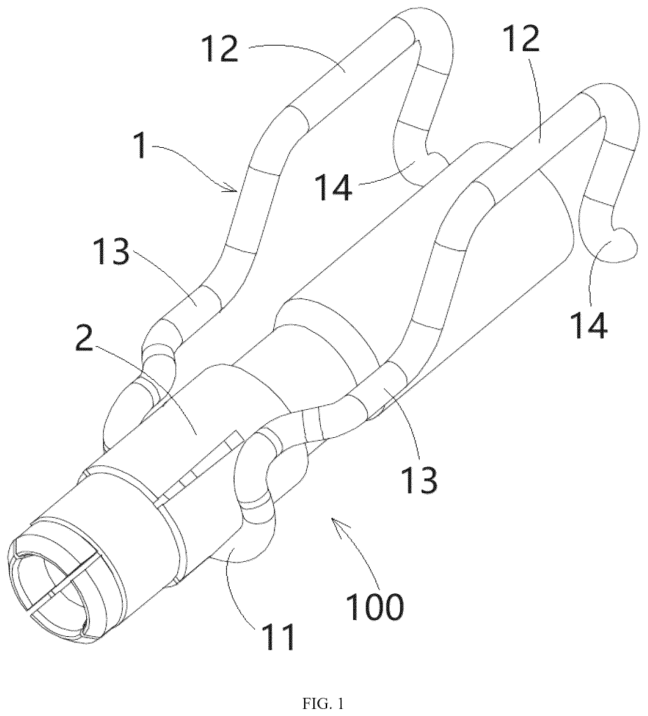

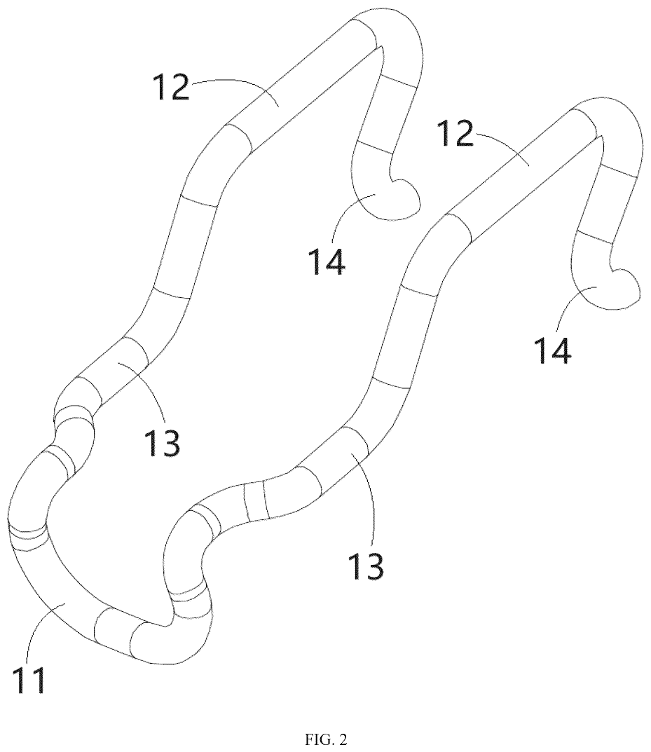

An exemplary embodiment of a grounding spring 1 will now be described with reference to FIGS. 1-10. As shown in FIGS. 1-4, the grounding spring 1 includes a C-shaped clamping portion 11 and an elastic contact portion 12. The C-shaped clamping portion 11 is adapted to clamp a grounding terminal 2 of a connector 400 to make electrical contact with the grounding terminal 2. The elastic contact portion 12 is adapted to abut against an inner side of an outer shielding shell 5 of the connector 400 to make electrical contact with the outer shielding shell 5. The grounding spring 1 is configured to electrically connect the grounding terminal 2 to the outer shielding shell 5.

The grounding spring 1, as shown in FIG. 1, is formed by bending a circular conductor having a predetermined length, to allow the grounding spring 1 to be an integral part. The grounding spring 1 manufactured in this way has a simple structure and lower cost.

As shown in FIGS. 1-6, the grounding spring 1 further includes a fixing portion 13. The fixing portion 13 is located between the C-shaped clamping portion 11 and the elastic contact portion 12 and adapted to be clamped in a slot 33 on a terminal retainer 3 of the connector 400 for mounting the grounding spring 1 to the terminal retainer 3.

The grounding spring 1 has a front end and a rear end opposite each other in an axial direction of the C-shaped clamping portion 11. As shown in FIGS. 1-4, the C-shaped clamping portion 11 is located at the front end of the grounding spring 1 and adapted to abut axially against a front end face 3a of the terminal retainer 3 to axially position the front end of the grounding spring 1.

As shown in FIGS. 1-3 and 5-6, the grounding spring 1 further includes a positioning portion 14 located at the rear end of the grounding spring 1 and adapted to be positioned in a positioning slot 34 of the terminal retainer 3. When the grounding spring 1 is mounted to the terminal retainer 3, the positioning portion 14 abuts axially against an inner wall surface of the positioning slot 34 to axially position the rear end of the grounding spring 1.

As shown in FIGS. 1-3, the grounding spring 1 further includes two fixing portions 13, two elastic contact portions 12 and two positioning portions 14. The two fixing portions 13 are connected to two ends of the C-shaped clamping portion 11, respectively. One elastic contact portion 12 is connected between one fixing portion 13 and one positioning portion 14, and the other elastic contact portion 12 is connected between the other fixing portion 13 and the other positioning portion 14.

As shown in FIGS. 1-3, the elastic contact portion 12 is U-shaped. When the grounding spring 1 is mounted to the terminal retainer 3, the elastic contact portion 12 protrudes from the terminal retainer 3 by a predetermined height to make electrical contact with the inner side of the outer shielding shell 5.

An exemplary embodiment of a grounding terminal assembly 100 will now be described with reference to FIGS. 1-10. As shown in FIG. 1, the grounding terminal assembly 100 includes a grounding terminal 2 and the above grounding spring 1. The C-shaped clamping portion 11 of the grounding spring 1 is clamped to the grounding terminal 2 to make electrical contact with the grounding terminal 2. The elastic contact portion 12 of the grounding spring 1 is configured to make electrical contact with an inner side of an outer shielding shell 5 of a connector 400 to electrically connect the grounding terminal 2 to the outer shielding shell 5.

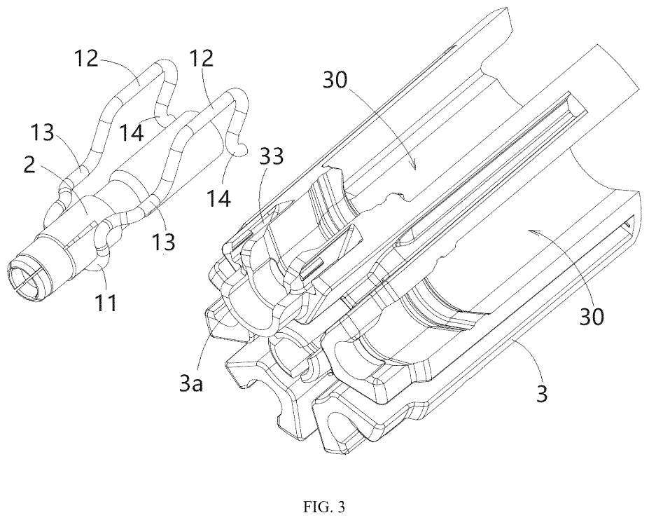

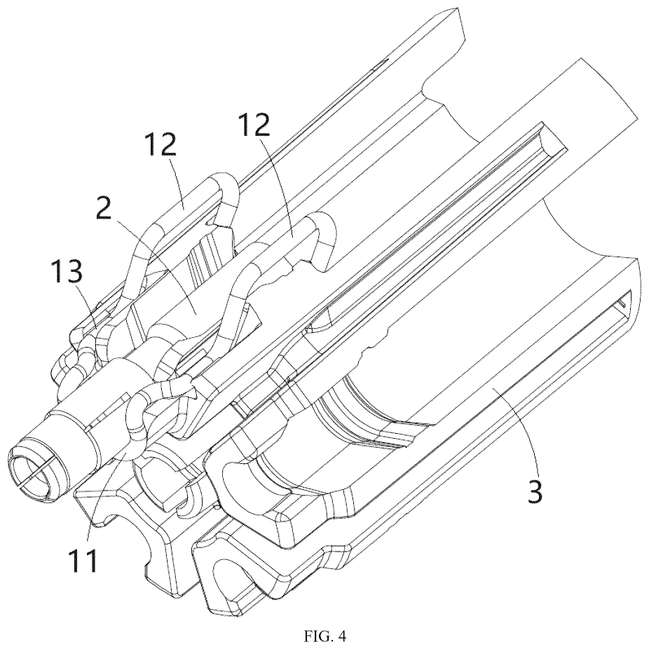

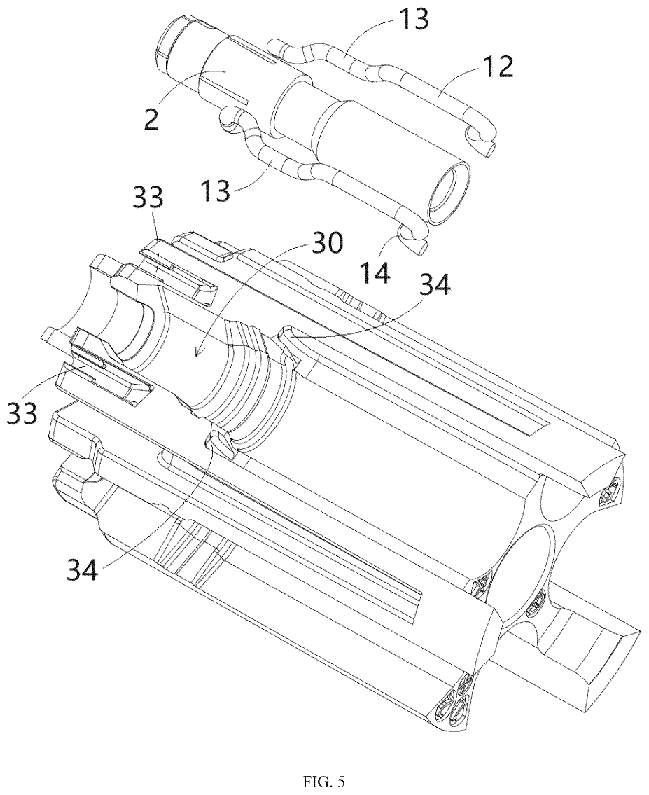

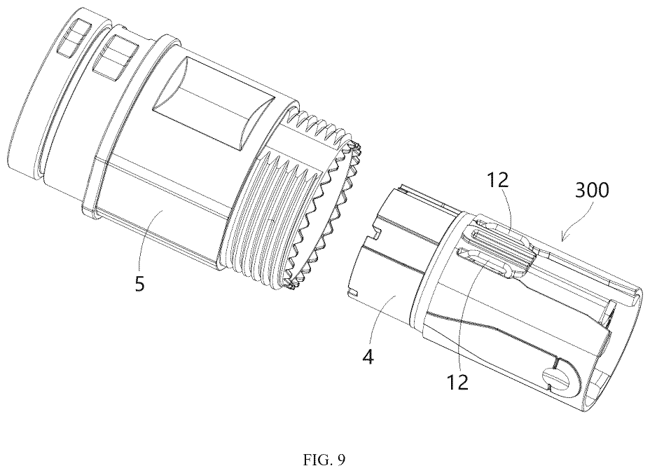

An exemplary embodiment of a connector 400 will now be described with reference to FIGS. 1-10. The connector 400 includes a terminal retainer 3, as shown in FIGS. 3-4, the grounding terminal assembly 100, as shown in FIG. 1, and an outer shielding shell 5, as shown in FIG. 9. As shown in FIGS. 3 and 5, a plurality of terminal mounting slots 30 are formed on an outer peripheral surface of the terminal retainer 3. The grounding terminal 2 of the grounding terminal assembly 100 is mounted in one terminal mounting slot 30 of the terminal retainer 3. The terminal retainer 3 and the grounding terminal assembly 100 are inserted into the outer shielding shell 5. The elastic contact portion 12 of the grounding spring 1 abuts against an inner side of the outer shielding shell 5 to electrically connect the grounding terminal 2 to the outer shielding shell 5.

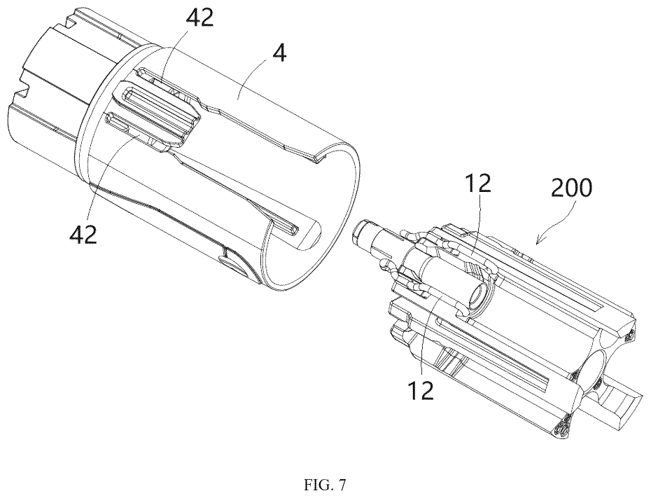

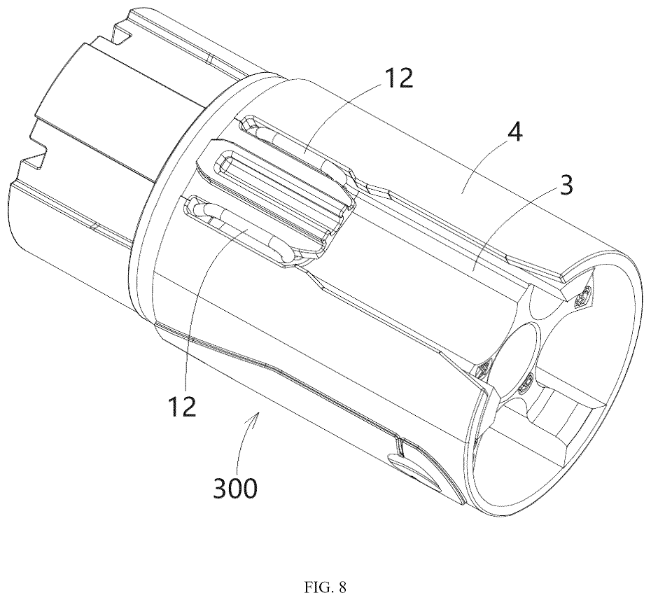

As shown in FIGS. 7-8, the connector 400 further includes an inner insulating shell 4. The terminal retainer 3 and the grounding terminal assembly 100 are inserted into the inner insulating shell 4. The inner insulating shell 4 is inserted into the outer shielding shell 5, and a slot hole 42, as shown in FIG. 7, is formed on the inner insulating shell 4. The elastic contact portion 12 of the grounding spring 1 protrudes from the inner insulating shell 4 via the slot hole 42, as shown in FIGS. 8-9, and abuts against the inner side of the outer shielding shell 5.

As shown in FIGS. 3 and 5, a slot 33 is formed on the terminal retainer 3. The fixing portion 13 of the grounding spring 1 is clamped into the slot 33, such that the grounding spring 1 is retained on the terminal retainer 3.

As shown in FIGS. 3 and 5, the plurality of terminal mounting slots 30 extend along an axial direction of the terminal retainer 3 and are spaced apart in a circumferential direction of the terminal retainer 3. The C-shaped clamping portion 11 of the grounding spring 1 abuts axially against a front end face 3a of the terminal retainer 3 to axially position a front end of the grounding spring 1.

As shown in FIG. 5, a positioning slot 34 is formed on the terminal retainer 3. The positioning portion 14 of the grounding spring 1 is positioned in the positioning slot 34 of the terminal retainer 3 and abuts axially against an inner wall surface of the positioning slot 34 to axially position a rear end of the grounding spring 1.

The connector 400 further includes a plurality of power terminals, each of the power terminals being mounted in one corresponding terminal mounting slot 30 of the terminal retainer 3. The connector 400 further includes: a grounding wire and a plurality of power wires. The grounding wire is electrically connected to a rear end of the grounding terminal 2. The plurality of power wires are electrically connected to rear ends of the plurality of power terminals, respectively. The grounding wire and the plurality of power wires extend from a rear end of the outer shielding shell 5.

A front end of the grounding terminal 2 is adapted to mate with a mating grounding terminal of a mating connector, and the rear end of the grounding terminal 2 is adapted to be crimped to the grounding wire. Front ends of the power terminals are adapted to mate with mating power terminals of the mating connector, and the rear ends of the power terminals are adapted to be crimped to the power wires.

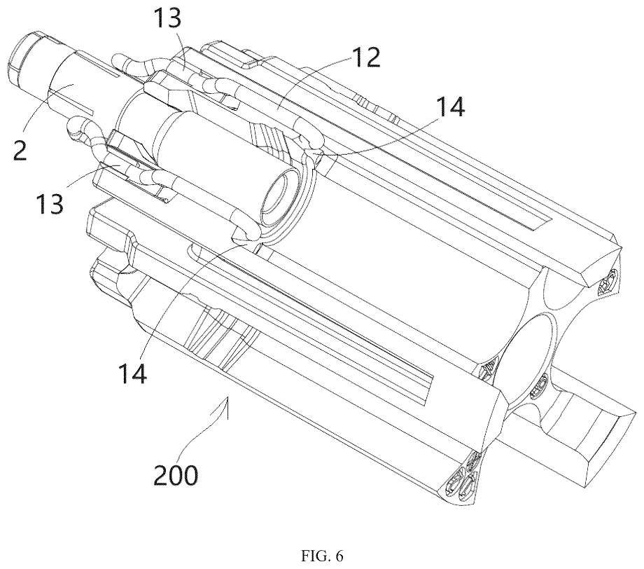

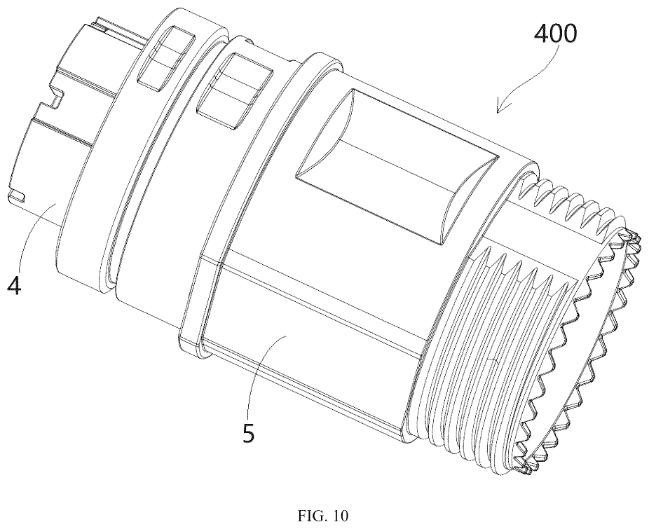

As shown in FIG. 6, the terminal retainer 3 and the grounding terminal 2, the power terminal and the grounding spring 1 mounted thereon together form an insert module 200, which is adapted to be inserted into the inner insulating shell 4. The inner insulating shell 4 and the insert module 200 inserted therein, as shown in FIG. 8, together form a connector module 300. The connector module 300 is adapted to be inserted into the outer shielding shell 5. As shown in FIG. 10, the outer shielding shell 5 and the connector module 300 inserted therein together form the connector 400.

In the aforementioned various exemplary embodiments according to the present invention, the grounding spring 1 has a simple structure, thereby it is possible to simplify the structure of the connector 400 and reduce the number of components of the connector 400, thus reducing the cost and improving the production efficiency.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “including” an element or a plurality of elements having a particular property may include additional such elements not having that property.

1. A grounding spring, comprising:
a C-shaped clamping portion clamping a grounding terminal of a connector to make electrical contact with the grounding terminal; and
an elastic contact portion abutting against an inner side of an outer shielding shell of the connector to make electrical contact with the outer shielding shell, the grounding spring electrically connects the grounding terminal to the outer shielding shell.

2. The grounding spring of claim 1, wherein the grounding spring is an integral part formed by bending a circular conductor having a predetermined length.

3. The grounding spring of claim 1, further comprising a fixing portion between the C-shaped clamping portion and the elastic contact portion, the fixing portion is clamped in a slot on a terminal retainer of the connector for mounting the grounding spring to the terminal retainer.

4. The grounding spring of claim 3, wherein the grounding spring has a front end and a rear end opposite each other in an axial direction of the C-shaped clamping portion, the C-shaped clamping portion is at the front end of the grounding spring and abuts axially against a front end face of the terminal retainer to axially position the front end of the grounding spring.

5. The grounding spring of claim 4, further comprising a positioning portion at the rear end of the grounding spring, the positioning portion is positioned in a positioning slot of the terminal retainer.

6. The grounding spring of claim 5, wherein, when the grounding spring is mounted to the terminal retainer, the positioning portion abuts axially against an inner wall surface of the positioning slot to axially position the rear end of the grounding spring.

7. The grounding spring of claim 1, wherein the grounding spring has two fixing portions, two elastic contact portions, and two positioning portions, each fixing portion is connected to one of two ends of the C-shaped clamping portion.

8. The grounding spring of claim 7 wherein one elastic contact portion is connected between one fixing portion and one positioning portion, and another elastic contact portion is connected between another fixing portion and another positioning portion.

9. The grounding spring of claim 1, wherein the elastic contact portion is U-shaped, when the grounding spring is mounted to a terminal retainer of the connector, the elastic contact portion protrudes from the terminal retainer by a predetermined height to make electrical contact with the inner side of the outer shielding shell.

10. A grounding terminal assembly, comprising:
a grounding terminal; and
a grounding spring including a C-shaped clamping portion and an elastic contact portion, the C-shaped clamping portion is clamped to the grounding terminal to make electrical contact with the grounding terminal, the elastic contact portion abuts against an inner side of an outer shielding shell of a connector to electrically connect the grounding terminal to the outer shielding shell.

11. A connector, comprising:
a terminal retainer having a plurality of terminal mounting slots formed on an outer peripheral surface thereof;
a grounding terminal assembly including a grounding terminal and a grounding spring, the grounding spring includes a C-shaped clamping portion and an elastic contact portion, the C-shaped clamping portion is clamped to the grounding terminal to make electrical contact with the grounding terminal, the grounding terminal is mounted in one terminal mounting slot; and
an outer shielding shell, the terminal retainer and the grounding terminal assembly are inserted into the outer shielding shell, the elastic contact portion abuts against an inner side of the outer shielding shell to electrically connect the grounding terminal to the outer shielding shell.

12. The connector of claim 11, further comprising an inner insulating shell, the terminal retainer and the grounding terminal assembly are inserted into the inner insulating shell, and the inner insulating shell is inserted into the outer shielding shell.

13. The connector of claim 12, wherein a slot hole is formed on the inner insulating shell, the elastic contact portion protrudes from the inner insulating shell via the slot hole and abuts against the inner side of the outer shielding shell.

14. The connector of claim 11, wherein a slot is formed on the terminal retainer, a fixing portion of the grounding spring is clamped into the slot to retain the grounding spring on the terminal retainer.

15. The connector of claim 11, wherein the plurality of terminal mounting slots extend along an axial direction of the terminal retainer and are spaced apart in a circumferential direction of the terminal retainer, the C-shaped clamping portion abuts axially against a front end face of the terminal retainer to axially position a front end of the grounding spring.

16. The connector of claim 15, wherein a positioning slot is formed on the terminal retainer, and a positioning portion of the grounding spring is positioned in the positioning slot, the positioning portion abuts axially against an inner wall surface of the positioning slot to axially position a rear end of the grounding spring.

17. The connector of claim 11, further comprising a plurality of power terminals, each of the power terminals is mounted in one terminal mounting slot.

18. The connector of claim 17, further comprising a grounding wire electrically connected to a rear end of the grounding terminal, and a plurality of power wires electrically connected to rear ends of the plurality of power terminals, respectively, the grounding wire and the plurality of power wires extend from a rear end of the outer shielding shell.

19. The connector of claim 18, wherein a front end of the grounding terminal mates with a mating grounding terminal of a mating connector, the rear end of the grounding terminal is crimped to the grounding wire, front ends of the power terminals mate with mating power terminals of the mating connector, the rear ends of the power terminals are crimped to the power wires.
